(19) United States
(12) Patent Application Publication
(10) Pub. No.: US 2026/0356108 A1
(43) Pub. Date: Nov. 12, 2026

(54) SHEET CONVEYING DEVICE AND IMAGE FORMING SYSTEM

(71) Applicant: KYOCERA Document Solutions Inc., Osaka (JP)

(72) Inventors: Takashi KOTANI, Osaka (JP); Toshiaki INOUE, Osaka (JP)

(73) Assignee: KYOCERA Document Solutions Inc., Osaka (JP)

(21) Appl. No.: 19/666,703

(22) Filed: May 4, 2026

(30) Foreign Application Priority Data
May 9, 2025 (JP) 2025-078835

(51) Int. Cl. B41J 13/00; B41J 3/60; B41J 11/00; B41J 13/10

(52) U.S. Cl. CPC B41J 13/009; B41J 3/60; B41J 11/002; B41J 11/006; B41J 13/106

(57) ABSTRACT

A sheet conveying device includes a first conveying path, a second conveying path, and a branching mechanism. The first conveying path and the second conveying path are branched from a main conveying path at a branch point. The branching mechanism includes a guide plate, a cam, a biasing member, and a control part. The guide plate is rockable in a first posture for communicating the main conveying path with the first conveying path and a second posture for communicating the main conveying path with the second conveying path. The biasing member biases the guide plate to rock in the first posture. The cam rotates to rock the guide plate in the second posture. The control part controls the cam such that the guide plate is biased by the biasing member to be rocked in the first posture when a paper jam occurs in one of the conveying paths.

### INCORPORATION BY REFERENCE

This application is based on and claims the benefit of priority from Japanese patent application No. 2025-078835 filed on May 9, 2025 which is incorporated by reference in its entirety.

### BACKGROUND

The present disclosure relates to a sheet conveying device which conveys a sheet along a conveying path having a branch point and an image forming system including the sheet conveying device.

In an image forming system including a sheet feeding device, an image forming device, a drying device, and a post-processing device, the drying device is formed such that a sheet conveying path branches at a plurality of positions in order to correspond to the number of sheets and to correspond to single-sided printing and double-sided printing. For example, in the case of single-sided printing, the sheet is dried by the drying device and then conveyed to the post-processing device. On the other hand, in the case of double-sided printing, the sheet is returned to the image forming device after being dried by the drying device.

A guide plate is arranged at the branch position of the conveying path to switch the conveying destination of the sheet. The guide plate is supported so as to be rockable in a posture for guiding the sheet to one conveying path and another posture for guiding the sheet to the other conveying path. For example, the posture of the guide plate is switched by a torsion coil spring and a cam. In some cases, a solenoid is used to switch the posture of the guide plate.

### SUMMARY

A sheet conveying device includes a first conveying path, a second conveying path, and a branching mechanism. The first conveying path and the second conveying path are branched from a main conveying path at a branch point. The branching mechanism makes the main conveying path communicate with either the first conveying path or the second conveying path at the branch point. The branching mechanism includes a guide plate, a cam, a biasing member, and a control part. The guide plate is rockable in a first posture for communicating the main conveying path with the first conveying path and a second posture for communicating the main conveying path with the second conveying path. The biasing member biases the guide plate so as to rock in the first posture. The cam rotates to rock the guide plate in the second posture against the biasing force of the biasing member. The control part controls a rotation of the cam such that the guide plate is biased by the biasing member to be rocked in the first posture when a paper jam occurs in one of the conveying paths.

An image forming system according to the present disclosure includes the sheet conveying device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inside of an image forming system including a sheet conveying device according to one embodiment of the present disclosure.

FIG. 2 is a front view schematically showing an inside of the sheet conveying device according to the embodiment of the present disclosure.

FIG. 3 is a perspective view showing a branching mechanism (a state in which a guide plate is rocked in a first posture) of the sheet conveying device according to the embodiment of the present disclosure.

FIG. 4 is a perspective view showing the branching mechanism (a state in which the guide plate is rocked in a second posture) of the sheet conveying device according to the embodiment of the present disclosure.

FIG. 5 is a cross-sectional view showing the branching mechanism (the state in which the guide plate is rocked in the first posture) of the sheet conveying device according to the embodiment of the present disclosure.

FIG. 6 is a cross-sectional view showing the branching mechanism (the state in which the guide plate is rocked in the second posture) of the sheet conveying device according to the embodiment of the present disclosure.

FIG. 7 is a block diagram showing a control part of the sheet conveying device according to the embodiment of the present disclosure.

### DETAILED DESCRIPTION

Hereinafter, with reference to the drawings, an image forming system and a drying device as an example of the sheet conveying device according to an embodiment of the present disclosure will be described.

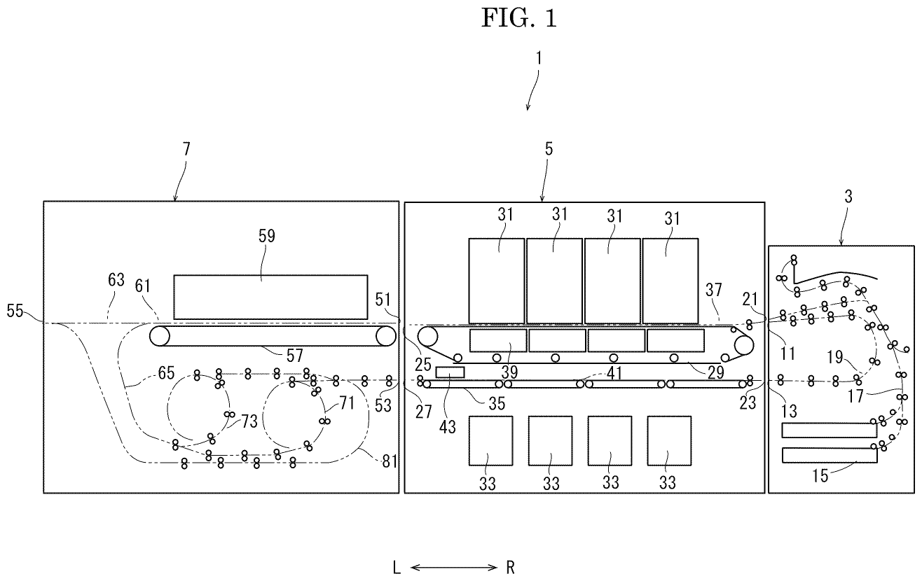

First, with reference to FIG. 1, the image forming system 1 including a drying device 7 will be described. FIG. 1 is a front view schematically showing the inside of the image forming system 1. L, R, Fr, and Rr appropriately attached to each drawing indicate the left side, the right side, the front side, and the rear side of the image forming system 1, respectively.

The image forming system 1 includes a sheet feeding device 3, an image forming device 5, the drying device 7, and a post-processing device (not shown). The sheet feeding device 3 stores a sheet and feeds the sheet to the image forming device 5. The image forming device 5 is disposed on the left side of the sheet feeding device 3, and forms an image on the sheet fed from the sheet feeding device 3 by an inkjet method based on image data input from an external computer, for example. The drying device 7 is disposed on the left side of the image forming device 5, and dries ink while conveying the sheet on which the image is formed by the ink. The post-processing device is disposed on the left side of the drying device 7, and performs post-processing on the sheet having the ink dried by the drying device 7.

First, the sheet feeding device 3 will be described. A discharge port 11 and a receiving port 13 are formed on the left side surface of the sheet feeding device 3. The discharge port 11 is disposed on the upper portion of the left side surface, and the receiving port is disposed below the discharge port 11. In the sheet feeding device 3, a sheet feeding path 17 from a sheet feeding cassette 15 to the discharge port 11 and an inversion path 19 from the receiving port 13 to the discharge port 11 are formed.

Next, the image forming device 5 will be described. A right receiving port 21 and a right discharge port 23 are formed on the right side surface of the image forming device 5. The right receiving port 21 is disposed so as to face the discharge port 11 of the sheet feeding device 3. The sheet discharged through the discharge port 11 of the sheet feeding device 3 is received by the image forming device 5 through the right receiving port 21. The right discharge port 23 is disposed so as to face the receiving port 13 of the sheet feeding device 3. The sheet discharged through the right discharge port 23 is received by the sheet feeding device 3 through the receiving port 13. Further, on the left side surface of the image forming device 5, a left discharge port 25 and a left receiving port 27 are formed. The left discharge port 25 is disposed on the upper portion of the left side surface, and the left receiving port 27 is disposed on the lower portion of the left side surface.

The image forming device 5 includes one main conveying belt 29, four head units 31, four ink containers 33, and four double-sided printing conveying belts 35. The main conveying belt 29 is an endless belt having a number of fine through-holes penetrating in the thickness direction. The main conveying belt 29 is wound around a plurality of tension rollers, and a driving roller and a driven roller which are spaced apart from each other. By the rotation of the driving roller, the main conveying belt 29 travels in the counterclockwise direction in FIG. 1. The main conveying belt 29 traveling along the upper traveling track forms a main conveying path 37 along which the sheet received through the right receiving port 21 is conveyed in the conveying direction toward the left discharge port 25. A plurality of suction devices 39 are arranged in the hollow portion of the main conveying belt 29. The suction device 39 generates a negative pressure in the through-holes of the main conveying belt 29 traveled along the upper traveling track and attracts the conveyed sheet to the main conveying belt 29.

The four head units 31 correspond to ink of four colors of black, cyan, magenta and yellow, and are arranged above the main conveying path 37 along the conveying direction. Each head unit 31 has a plurality (three in one example) of recording heads (not shown). Each recording head is provided with a large number of ink ejection nozzles. Each ink ejection nozzle ejects the ink downward. The four ink containers 33 contain the ink of the four colors of black, cyan, magenta and yellow, respectively, and are connected to the corresponding head units 31.

Each of the four double-sided printing conveying belts 35 is an endless belt wound around a driving roller and a driven roller which are spaced apart from each other in the left-and-right direction. The four double-sided printing conveying belts 35 are arranged below the main conveying belt 29 in line between the left receiving port 27 and the right discharge port 23. Each of the double-sided printing conveying belts 35 travels in the clockwise direction in FIG. 1. The double-sided printing conveying belt 35 traveling along the upper traveling track forms a double-sided printing conveying path 41 along which the sheet is conveyed in the conveying direction from the left receiving port 27 to the right discharge port 23.

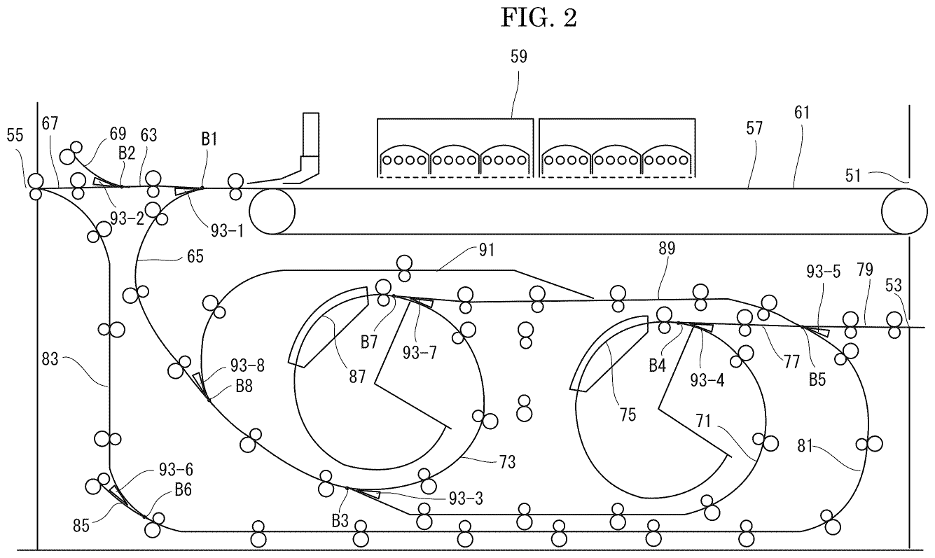

Next, the drying device 7, which is an example of the sheet conveying device according to the present disclosure, will be described with reference mainly to FIG. 2. FIG. 2 is a front view schematically showing the inside of the drying device 7. A right receiving port 51 and a right discharge port 53 are formed on the right side surface of the drying device 7. The right receiving port 51 is disposed so as to face the left discharge port 25 of the image forming device 5. The sheet discharged through the left discharge port 25 of the image forming device 5 is received by the drying device 7 through the right receiving port 51. The right discharge port 53 is disposed so as to face the left receiving port 27 of the image forming device 5. The sheet discharged through the right discharge port 53 is received by the image forming device 5 through the left receiving port 27. Further, a left discharge port 55 is formed on the upper portion of the left side surface of the drying device 7.

The drying device 7 includes a conveying belt 57 and a dryer 59. The conveying belt 57 is an endless belt wound around a driving roller and a driven roller which are spaced apart from each other in the left-and-right direction. By the rotation of the driving roller, the conveying belt 57 travels in the counterclockwise direction in FIG. 2. The conveying belt 57 traveling along the upper traveling track forms a main conveying path 61 along which the sheet received through the right receiving port 51 is conveyed in the conveying direction toward the left discharge port 55. The dryer 59 is disposed above the main conveying path 61.

The main conveying path 61 branches into a first discharge path 63 extending leftward and an inversion path 65 extending downward at a branch point B1. The first discharge path 63 branches into a second discharge path 67 toward the left discharge port 55 and a third discharge path 69 extending upward at a branch point B2.

The inversion path 65 branches into a first inversion path 71 and a second inversion path 73 at a branch point B3. The first inversion path 71 extends rightward from the branch point B3 and is curved upward in an arc shape. The second inversion path 73 is curved upward from the branch point B3 in an arc shape. The first inversion path 71 branches into a first escape path 75 and a first return path 77 at a branch point B4. The first return path 77 branches into a second return path 79 and a fourth discharge path 81 at a branch point B5. The second return path 79 is formed between the branch point B5 and the right discharge port 53. The fourth discharge path 81 branches into a fifth discharge path 83 and a branch path 85 at a branch point B6. The fifth discharge path 83 is formed between the branch point B6 and the left discharge port 55. The second inversion path 73 branches into a second escape path 87 and a third return path 89 at a branch point B7. The third return path 89 merges with the first return path 77.

The inversion path 65 branches to a relay path 91 at the branch point B8 upstream of the branch point B3. The relay path 91 merges with the third return path 89.

A first branching mechanism 93-1 is arranged at the branch point B1. The first branching mechanism 93-1 makes the main conveying path 61 communicate with either the first discharge path 63 or the inversion path 65. A second branching mechanism 93-2 is arranged at the branch point B2. The second branching mechanism 93-2 makes the first discharge path 63 communicate with either the second discharge path 67 or the third discharge path 69. A third branching mechanism 93-3 is arranged at the branch point B3. The third branching mechanism 93-3 makes the inversion path 65 communicate with either the first inversion path 71 or the second inversion path 73.

A fourth branching mechanism 93-4 is arranged at the branch point B4. The fourth branching mechanism 93-4 makes the first inversion path 71 communicate with the first escape path 75 or makes the first escape path 75 communicate with the first return path 77. In the case of inverting the front and back surfaces of the sheet during double-sided printing, the fourth branching mechanism 93-4 makes the first inversion path 71 communicate with the escape path 75, and the sheet is conveyed from the first inversion path 71 to the first escape path 75. Thereafter, the fourth branching mechanism 93-4 makes the first escape path 75 with the first return path 77, and the sheet is conveyed from the first escape path 75 to the first return path 77. A fifth branching mechanism 93-5 is arranged at the branch point B5. The fifth branching mechanism 93-5 makes the first return path 77 communicate with either the second return path 79 or the fourth discharge path 81.

A sixth branching mechanism 93-6 is arranged at the branch point B6. The sixth branching mechanism 93-6 makes the fourth discharge path 81 communicate with either the fifth discharge path 83 or the branch path 85.

A seventh branching mechanism 93-7 is arranged at the branch point B7. The seventh branching mechanism 93-7 makes the second inversion path 73 communicate with the second escape path 87 or makes the second escape path 87 communicate with the third return path 89. In the case of inverting the front and back surfaces of the sheet during double-sided printing, the seventh branching mechanism 93-7 makes the second inversion path 73 with the second escape path 87, and the sheet is conveyed from the second inversion path 73 to the second escape path 87. Thereafter, the seventh branching mechanism 93-7 makes the second escape path 87 communicate with the third return path 89, and the sheet is conveyed from the second escape path 87 to the third return path 89.

An eighth branching mechanism 93-8 is arranged at the branch point B8. The eighth branching mechanism 93-8 makes the downstream portion of the inversion path 65 communicate with either the upstream portion of the inversion path 65 or the relay path 91. The branching mechanisms 93-1 to 93-8 have the same structure. The branching mechanisms 93-1 to 93-8 are collectively referred to as the branching mechanism 93.

Next, the image forming operation of the image forming system 1 will be briefly described with reference to FIG. 1 and FIG. 2. The sheet discharged through the discharge port 11 of the sheet feeding device 3 is received by the image forming device 5 through the right receiving port 21 of the image forming device 5, and conveyed along the main conveying path 37. The sheet is conveyed while being attracted by the main conveying belt 29. At this time, the ink of the four colors are ejected from the four head units 31 according to the image data to form an image on the sheet. The sheet on which the image is formed is discharged through the left discharge port 25 and received by the drying device 7 through the right receiving port 51 of the drying device 7. The sheet is conveyed along the main conveying path 61. At this time, the ink is dried by the dryer 59.

In the case of single-sided printing of only one sheet, the sheet is conveyed from the main conveying path 61 through the first discharge path 63 and the second discharge path 67 to the post-processing device through the left discharge port 55. In the case of single-sided printing of a plurality of sheets, the sheets are conveyed from the main conveying path 61 to the inversion path 65, and alternately conveyed to the first inversion path 71 and the second inversion path 73. The sheet conveyed to the first inversion path 71 is conveyed to the first escape path 75, switched back, and conveyed from the first escape path 75 through the first return path 77, the fourth discharge path 81, and the fifth discharge path 83 to the post-processing device through the left discharge port 55. The sheet conveyed to the second inversion path 73 is conveyed to the second escape path 87, switched back, and conveyed from the second escape path 87 through the third return path 89, the first return path 77, the fourth discharge path 81, and the fifth discharge path 83 to the post-processing device through the left discharge port 55. The sheets switched back by the first inversion path 71 and the second inversion path 73 are sequentially conveyed to the post-processing device with the printed surface facing downward.

In the case of double-sided printing, the sheet is conveyed from the main conveying path 61 to the inversion path 65, and is alternately conveyed to the first inversion path 71 and the second inversion path 73. The sheet conveyed to the first inversion path 71 is conveyed to the first escape path 75, switched back, and returned from the first escape path 75 through the first return path 77 and the second return path 79 to the image forming device 5 through the right discharge port 53. The sheet conveyed to the second inversion path 73 is conveyed to the second escape path 87, switched back, and returned from the second escape path 87 to the image forming device 5 through the third return path 89, the first return path 77, and the second return path 79 through the right discharge port 53. The sheets switched back by the first inversion path 71 and the second inversion path 73 are sequentially conveyed to the image forming device 5 with the printed surface facing upward.

In the image forming device 5, the sheet is conveyed along the double-sided printing conveying path 41 with the printed surface facing upward. Thereafter, the sheet is conveyed to the inversion path 19 of the sheet feeding device 3 through the right discharge port 23 and through the receiving port 13, and returned in the image forming device 5 again through the discharge port 11 and the right receiving port 21. At this time, the front and back surfaces of the sheet is inverted, and the sheet is conveyed along the main conveying path 37 with the printed surface facing downward. Thereafter, the sheet is conveyed to the drying device 7, after the ink is dried, and then conveyed to the post-processing device, as in the case of single-sided printing of one sheet.

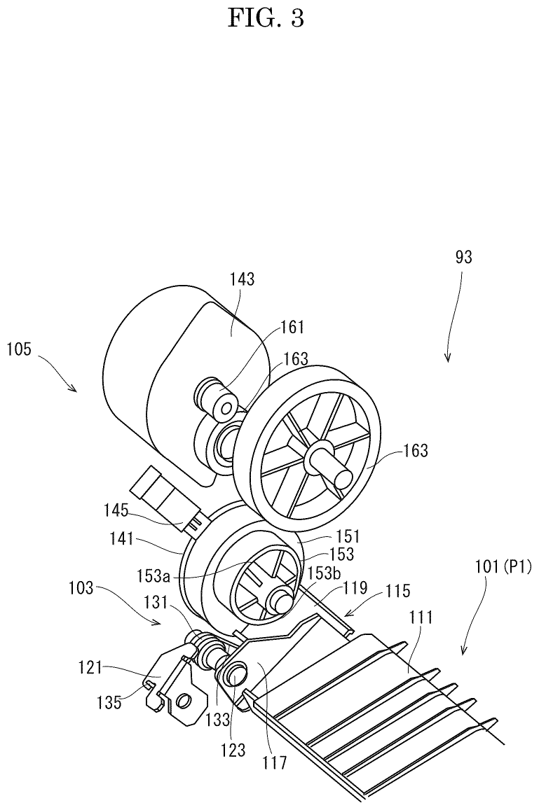

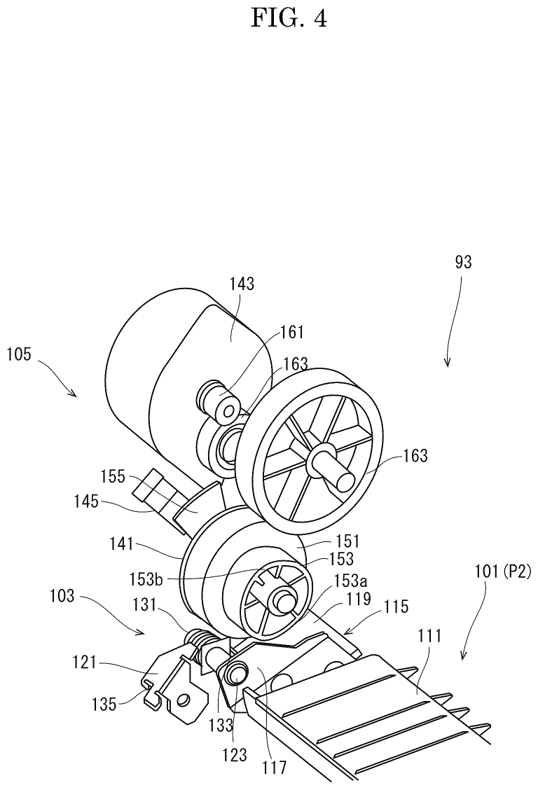

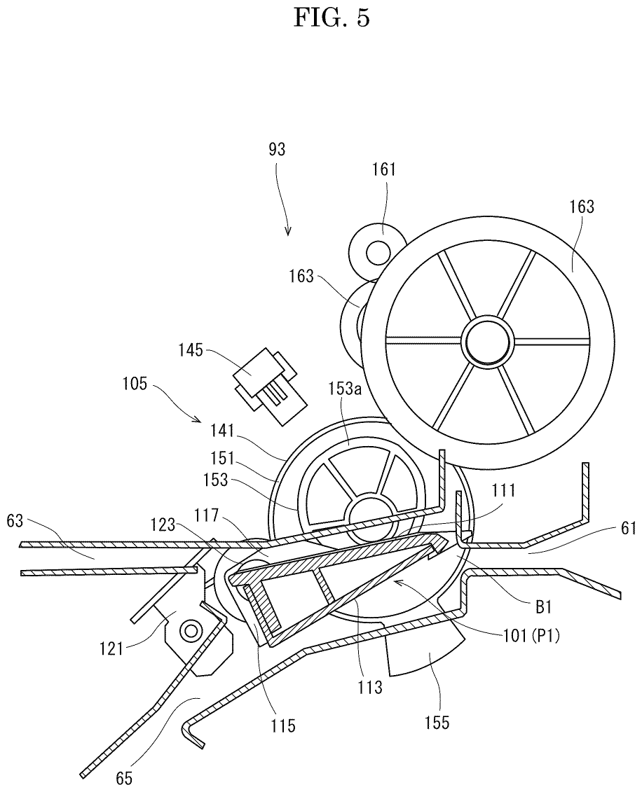

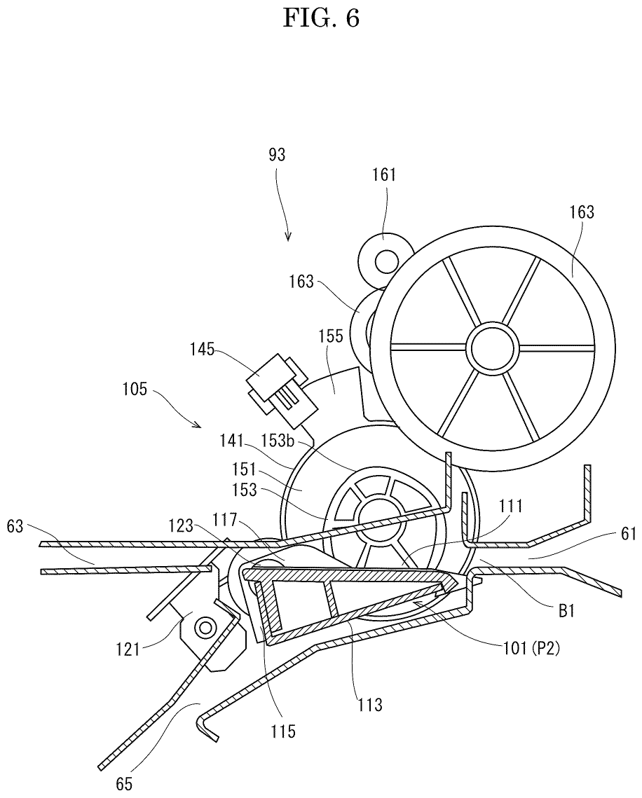

Next, the branching mechanism 93 will be described with reference to FIG. 3 to FIG. 6. FIG. 3 and FIG. 4 are perspective views showing the branching mechanism 93, and FIG. 5 and FIG. 6 are cross-sectional views showing the branching mechanism 93. The branching mechanism 93 includes a guide plate 101, a biasing member 103, and a cam mechanism 105. Here, the first branching mechanism 93-1 arranged at the branch point B1 will be described. As described above, the first branching mechanism 93-1 makes the main conveying path 61 communicate with either the inversion path 65 or the first discharge path 63. The conveying direction is a direction from the main conveying path 61 toward the first discharge path 63 or the inversion path 65.

First, the guide plate 101 will be described. The guide plate 101 is a member which is long in the width direction of the sheet and has a triangular cross-sectional shape. As shown in FIG. 5 and FIG. 6, the guide plate 101 has a first guide surface 111 and a second guide surface 113 intersecting at an acute angle at one vertex of the triangle. A plurality of ribs are formed on the first guide surface 111 and the second guide surface 113 at predetermined intervals in the width direction along the conveying direction. As shown in FIG. 3 and FIG. 4, a movable-side bracket 115 is fixed to the rear end portion of the guide plate 101.

The movable-side bracket 115 has a support piece 117 orthogonal to the first guide surface 111 and the second guide surface 113, and a pressed piece 119 orthogonal to the support piece 117. As shown in FIG. 5 and FIG. 6, the guide plate 101 is disposed in a posture in which the intersection of the first guide surface 111 and the second guide surface 113 faces the branch point B1 from the downstream side of the conveying direction. That is, the first guide surface 111 faces the first discharge path 63, and the second guide surface 113 faces the inversion path 65. As shown in FIG. 3 and FIG. 4, the downstream end of the support piece 117 of the movable-side bracket 115 is connected to a fixed-side bracket 121 fixed to the main body of the drying device 7 via a rocking shaft 123 extending in the front-and-rear direction.

The guide plate 101 is rocked around the rocking shaft 123 upward and downward. When the guide plate 101 is rocked upward (referred to as the first posture P1), the main conveying path 61 communicates with the inversion path 65 (see FIG. 5), and when the guide plate 101 is rocked downward (referred to as the second posture P2), the main conveying path 61 communicates with the first discharge path 63 (see FIG. 6).

Next, the torsion coil spring as the biasing member 103 will be described. As shown in FIG. 3 and FIG. 4, the coil portion 131 of the torsion coil spring 103 is externally fitted around the rocking shaft 123. One arm portion 133 of the torsion coil spring 103 is engaged with the movable-side bracket 115, and the other arm portion 135 is engaged with the fixed-side bracket 121. The torsion coil spring 103 biases the guide plate 101 in the first posture (upward) via the movable-side bracket 115 (see FIG. 3 and FIG. 5). That is, the torsion coil spring 103 rocks the guide plate 101 so as to make the main conveying path 61 communicate with the inversion path 65.

Next, the cam mechanism 105 will be described. The cam mechanism 105 includes a cam gear 141, a motor 143, and an optical sensor 145. The cam gear 141 has a gear portion 151, a cam portion 153, and a light shielding piece 155. The cam portion 153 is formed coaxially with the gear portion 151 on one surface of the gear portion 151. The cam portion 153 is formed such that the distance from the center to the outer peripheral surface changes smoothly, and has a maximum diameter portion 153a and a minimum diameter portion 153b. The maximum diameter portion 153a and the minimum diameter portion 153b are arranged at an angle of approximately 180 degrees with respect to the center of the cam gear 141. The light shielding piece 155 is fan-shaped, and projects radially from the outer peripheral surface of the gear portion 151. The center angle of the light shielding piece 155 is approximately 30 degrees. The light shielding piece 155 is formed at substantially the same position as the minimum diameter portion 153b of the cam portion 153 in the circumferential direction of the cam gear 141.

The cam gear 141 is arranged such that the cam portion 153 abuts on the pressed piece 119 of the movable-side bracket 115 of the guide plate 101 from above with the rotational shaft in parallel with the rocking shaft 123 of the guide plate 101. In the state where the minimum diameter portion 153b of the cam portion 153 is in contact with the pressed piece 119, little downward force is applied from the minimum diameter portion 153b to the pressed piece 119, and the pressed piece 119 is only in contact with the cam portion 153. Therefore, the guide plate 101 is biased by the torsion coil spring 103 and rocked in the first posture. When the cam gear 141 rotates and the maximum diameter portion 153a of the cam portion 153 is in contact with the pressed piece 119 of the movable-side bracket 115, a downward force is applied to the pressed piece 119, and the movable-side bracket 115 is pushed down. Thus, the guide plate 101 is rocked in the second posture against the biasing force of the torsion coil spring 103.

A motor gear 161 fixed to a motor shaft of the motor 143 is meshed with the gear portion 151 of the cam gear 141 through two idle gears 163.

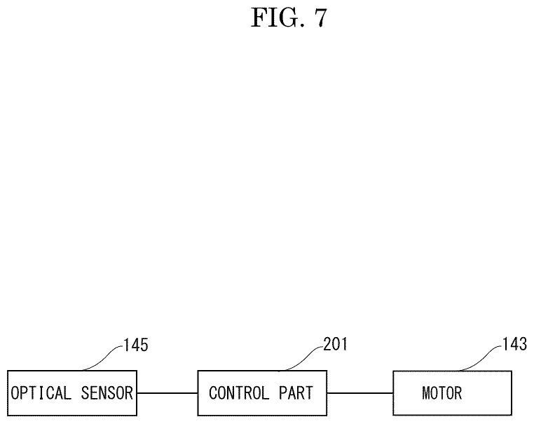

The optical sensor 145 has a light emitting part and a light receiving part, and forms an optical path between the light emitting part and the light receiving part. When the optical path is formed, the optical sensor 145 outputs an OFF signal to the control part 201 (see FIG. 7), and when the optical path is blocked, the optical sensor 145 outputs an ON signal to the control part 201. The optical sensor 145 is fixed to the device body such that the optical path crosses the moving locus of the light shielding piece 155 of the cam gear 141. Further, the optical sensor 145 is arranged such that the optical path is blocked by the light shielding piece 155 of the cam gear 141 in a state where the maximum diameter portion 153a of the cam portion 153 pushes down the pressed piece 119 of the movable-side bracket 115 and the guide plate 101 is rocked in the second posture (see FIG. 4 and FIG. 6).

Next, the control part 201 will be described with reference to the block diagram of FIG. 7. The ON signal or the OFF signal is input from the optical sensor 145 to the control part 201. As described above, when the guide plate 101 is rocked in the second posture, the light path is blocked by the light shielding piece 155 of the cam gear 141, so that the ON signal is input from the optical sensor 145 to the control part 201. As described above, since the optical sensor 145 is arranged such that the optical path is blocked by the light shielding piece 155 of the cam gear 141 in the state where the cam portion 153 pushes down the movable-side bracket 115 and the guide plate 101 is rocked in the second posture, when the ON signal is input from the optical sensor 145, the control part 201 determines that the guide plate 101 is rocked in the second posture. The control part 201 controls the drive of the motor 143 according to the input signal.

Here, the main conveying path 61 is an example of the main conveying path according to the present disclosure, the inversion path 65 is an example of the first conveying path according to the present disclosure, and the first discharge path 63 is an example of the second conveying path according to the present disclosure. As described above, the main conveying path in the present disclosure indicates a conveying path upstream of the branch point, and the first conveying path and the second conveying path indicate two conveying paths branched at the branch point.

The operation of the branching mechanism 93 having the above configuration will be described. First, a case where the sheet is conveyed from the main conveying path 61 to the first discharge path 63, that is, a case where the guide plate 101 is rocked in the second posture will be described. When the control part 201 drives the motor 143, the cam gear 141 rotates through the motor gear 161 and the two idle gears 163. When the cam gear 141 rotates and the light shielding piece 155 crosses the optical path of the optical sensor 145, the optical path is blocked and the optical sensor 145 outputs the ON signal to the control part 201. When the ON signal is inputted, the control part 201 determines that the guide plate 101 is rocked in the second posture, and thereafter, after rotating the motor gear 161 of the motor 143 by a predetermined first angle (for example, 30 degrees), stops driving the motor 143. During this time, the optical path is being blocked by the light shielding piece 155.

Next, a case where the sheet is conveyed from the main conveying path 61 to the inversion path 65, that is, a case where the guide plate 101 is rocked in the first posture will be described. The control part 201 further rotates the motor shaft by a predetermined second angle (180 degrees) from the state in which the motor gear 161 is rotated by the predetermined first angle as described above, and then stops driving the motor 143. Then, the minimum diameter portion 153b of the cam portion 153 of the cam gear 141 is in contact with the pressed piece 119 of the movable-side bracket 115. As described above, when the minimum diameter portion 153b of the cam portion 153 is in contact with the pressed piece 119, little downward force is applied from the cam portion 153 to the movable-side bracket 115, so that the guide plate 101 is biased by the torsion coil spring 103 and rocked in the first posture.

Next, a case where a sheet jam occurs in any one of the conveying paths of the drying device 7 will be described. When the sheet jam occurs, the sheet conveying stops. In the branching mechanism 93, the control part 201 drives the motor 143. Then, the cam gear 141 rotates as described above, and when the light shielding piece 155 crosses the optical path of the optical sensor 145, the optical sensor 145 outputs the ON signal to the control part 201. The control part 201 rotates the motor gear 161 by the predetermined first angle (for example, 30 degrees) after the ON signal is inputted, and then rotates it by the predetermined second angle (180 degrees). In this manner, the guide plate 101 is rocked in the first posture. In this manner, in the state where the sheet jam occurs, the guide plate 101 is rocked in the first posture in all the branching mechanisms 93.

As described above, according to the present disclosure, when the sheet jam occurs, the guide plate 101 is biased by the torsion coil spring 103 and rocked in the first posture. Therefore, in a case where the sheet crosses the branch point in the state where the sheet jam occurs and the conveying of the sheet is stopped, the guide plate 101 can be rocked against the biasing force of the torsion coil spring 103.

On the other hand, when the guide plate 101 is rocked in the second posture, it is difficult to turn the guide plate 101 because the movable-side bracket 115 is pushed down by the cam gear 141 by the force of the motor 143. For this reason, a strong force is required to remove the sheet, or the sheet may be torn. In this embodiment, since the guide plate 101 can be rocked by a light force, the sheet can be easily removed.

Since the drying device 7 includes the escape path and the return path to the image forming device 5, there are the plurality of branch points as described above, and the branching mechanism 93 is provided at each branch point. Each branching mechanism 93 is independently driven. When the sheet jam occurs, the guide plates 101 are rocked in the first posture in all the branching mechanisms 93, so that the sheet can be surely removed regardless of the state in which the sheet stops at the branch point. It should be noted that the branching mechanism 93 of the present disclosure can be applied to a sheet conveying device including a branch point of sheet, and can be applied to the sheet feeding device 3 or the like including the branch point in addition to the drying device 7.

Preferably, the first conveying path (the inversion path 65 in this embodiment) communicating with the main conveying path (the main conveying path 61 in this embodiment) when the guide plate 101 is rocked in the first posture has a higher sheet conveying frequently than the second conveying path (the first discharge path 63 in this embodiment). In a case where the above-described rocking operation of the guide plate 101 cannot be performed at the time of sheet jam due to a failure of the branching mechanism 93 or the like, the sheet can be easily removed as described above when the guide plate 101 is biased by the torsion coil spring 103 to be rocked in the first posture and the conveying of the sheet is stopped.

Although the disclosure has been described with respect to certain embodiments, the disclosure is not limited to the foregoing embodiments. Variations, substitutions, and modifications may be made without departing from the scope and spirit of the disclosure, and the claims include all embodiments that may fall within the scope of the technical idea.

### Appendix 1

A sheet conveying device according to Appendix 1 includes:
a first conveying path and a second conveying path branched from a main conveying path at a branch point; and
a branching mechanism which makes the main conveying path communicate with either the first conveying path or the second conveying path at the branch point, wherein
the branching mechanism includes:
a guide plate rockable in a first posture for communicating the main conveying path with the first conveying path and a second posture for communicating the main conveying path with the second conveying path;
a biasing member which biases the guide plate so as to rock in the first posture;
a cam rotating to rock the guide plate in the second posture against the biasing force of the biasing member; and
a control part which controls a rotation of the cam such that the guide plate is biased by the biasing member to be rocked in the first posture when a paper jam occurs in one of the conveying paths.

### Appendix 2

The sheet conveying device according to Appendix 2 is the sheet conveying device according to Appendix 1, wherein
the branching mechanism includes a plurality of the branching mechanisms, and
when the paper jam occurs in any of the conveying paths, the control part controls the rotation of the cam such that the guide plates of all the branching mechanisms are biased by the biasing members to be rocked to the first posture.

### Appendix 3

The sheet conveying device according to Appendix 3 is the sheet conveying device according to Appendix 1 or 2, wherein
the branching mechanism includes a motor which rotates the cam, and
the guide plate is kept in the second posture by force of the motor.

### Appendix 4

The sheet conveying device according to Appendix 4 is the sheet conveying device according to any one of Appendixes 1 to 3, wherein
the conveying path is configured to receive the sheet on which an image is formed on one surface by an image forming device, and return the sheet to the image forming device after inverting the front and back surfaces of the sheet.

### Appendix 5

The sheet conveying device according to Appendix 5 is the sheet conveying device according to any one of Appendixes 1 to 4, wherein
the conveying path includes an escape path.

### Appendix 6

The sheet conveying device according to Appendix 6 is the sheet conveying device according to any one of Appendixes 1 to 5, wherein
the first conveying path has a higher conveying frequency than the second conveying path.

### Appendix 7

An image forming system according to Appendix 7 includes the sheet conveying device according to any one of Appendixes 1 to 6.

### Appendix 8

The image forming system according to Appendix 8 is the image forming system according to Appendix 7, wherein
the sheet conveying device is a drying device for drying an image of the sheet on which the image is formed by an inkjet image forming device.

What is claimed is:

1. A sheet conveying device comprising:
a first conveying path and a second conveying path branched from a main conveying path at a branch point; and
a branching mechanism which makes the main conveying path communicate with either the first conveying path or the second conveying path at the branch point, wherein
the branching mechanism includes:
a guide plate rockable in a first posture for communicating the main conveying path with the first conveying path and a second posture for communicating the main conveying path with the second conveying path;
a biasing member which biases the guide plate so as to rock in the first posture;
a cam rotating to rock the guide plate in the second posture against the biasing force of the biasing member; and
a control part which controls a rotation of the cam such that the guide plate is biased by the biasing member to be rocked in the first posture when a paper jam occurs in one of the conveying paths.

2. The sheet conveying device according to claim 1, wherein
the branching mechanism includes a plurality of the branching mechanisms, and
when the paper jam occurs in any of the conveying paths, the control part controls the rotation of the cam such that the guide plates of all the branching mechanisms are biased by the biasing members to be rocked to the first posture.

3. The sheet conveying device according to claim 1, wherein
the branching mechanism includes a motor which rotates the cam, and
the guide plate is kept in the second posture by force of the motor.

4. The sheet conveying device according to claim 1, wherein
the conveying path is configured to receive the sheet on which an image is formed on one surface by an image forming device, and return the sheet to the image forming device after inverting the front and back surfaces of the sheet.

5. The sheet conveying device according to claim 1, wherein
the conveying path includes an escape path.

6. The sheet conveying device according to claim 1, wherein
the first conveying path has a higher conveying frequency than the second conveying path.

7. An image forming system comprising:
the sheet conveying device according to claim 1.

8. The image forming system according to claim 7, wherein
the sheet conveying device is a drying device for drying an image of the sheet on which the image is formed by an inkjet image forming device.
